(19) United States
(12) Patent Application Publication
(10) Pub. No.: US 2009/0070168 A1
(43) Pub. Date: Mar. 12, 2009

(54) Enterprise energy management system with social network approach to data analysis

(75) Inventors: Greg Thompson, Murfreesboro, TN (US); John C. Van Gorp, Sidney (CA); Hubert Lindsay, Sooke (CA)

Correspondence Address: BRINKS HOFER GILSON & LIONE/PML, PO BOX 10395, CHICAGO, IL, 60610, US

(73) Assignee: Power Measurement Ltd.

(21) Appl. No.: 11/899,809

(22) Filed: Sep. 7, 2007

(51) Int. Cl. G06Q 10/00

(52) U.S. Cl. 705/7

(57) ABSTRACT

A system for analyzing power management data by a community of users having a common interest is disclosed. Power management related data is collected from multiple sources and categorized. The power management data can then be manipulated and presented based at least on the categorization thereof.

### BACKGROUND

1. Technical Field

This disclosure relates generally to monitoring energy related data. More specifically, the disclosure relates to a social network approach to power related data analysis.

2. Background Information

Monitoring of electrical energy by consumers and providers of electric power is a fundamental function within any electric power distribution system. Electrical energy may be monitored for such purposes as usage, equipment performance and power quality, or other purposes or combinations thereof.

Power quality can be affected by a number of factors outside of voltage and current fluctuations. Some of these factors include temperature fluctuations and other weather related conditions. Power quality related events may consist of events such as sags, swells, and spikes. Such events not only cause potential harm to equipment but can also result in large losses of revenue due to outages.

Devices that perform monitoring of electrical energy may include electromechanical devices, such as, for example, a residential billing meter, or intelligent electronic devices (“IED”). IED's typically include some form of memory and microprocessors executing software to execute desired power management functions. IED's include Programmable Logic Controllers (“PLC's”), Remote Terminal Units (“RTU's”), electric power meters such as revenue meters, protective relays, fault recorders and other devices which are coupled with power distribution networks to manage and control the distribution and consumption of electrical power. An IED may perform other functions such as, for example, power distribution system protection, management of power generation, management of energy distribution and management of energy consumption.

A typical consumer or supplier of electrical energy may have many IED's installed and operating throughout their operations. For example, an engineer in charge of the electricity for a corporation with several plants will likely be in charge of a number of IED's. The IED's may operate individually, or may operate as part of a monitoring system. Each of the IED's may require unique software configurations, or multiple devices may include the same software configurations. An Enterprise Energy Management (EEM) system may be used to configure and monitor the IED's, such as through a graphical user interface.

However, managing the electrical power distribution and configurations of devices can be extremely burdensome for the consumer. Furthermore, consumers in similar industries with similar configurations and similar needs may spend an extraordinary amount of time configuring their energy related systems and determining the root cause of an outage or a problem.

### SUMMARY

This disclosure combines the information collected by an Enterprise Energy Management (EEM) system with the global expertise of the internet community of users, subject matter experts and product and service providers. The Enterprise Energy Management System with Social Network Approach to Data Analysis architecture may be better understood with reference to the following drawings and description. Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

FIG. 1 is a high level view of an exemplary system architecture detailed view of an exemplary system architecture;

FIG. 2 is a flow diagram illustrating one embodiment of an exemplary system architecture;

FIG. 3 is a block diagram of one embodiment of a portion of the system architecture;

FIG. 4 is an alternate and more detailed illustration of one embodiment of a portion of the system architecture;

FIG. 5 is a detailed view of the modules that may be part of the profile module of FIG. 4;

FIG. 6 shows one embodiment of the relationship between attributes, attribute values and entities;

FIG. 7 illustrates the process of profiling a monitoring system by creating attributes and associating attribute values to data sources and measurements;

FIG. 8 illustrates the process of profiling users within the social data analysis service; and

FIG. 9 highlights one embodiment of the process of creating and managing shared data sets.

### DETAILED DESCRIPTION OF THE PREFERRED EMBODIMENTS

Currently, online systems exist where a consumer can upload a data set and view subsets of the data. Online community services also exist where similar users can post messages regarding their concerns and even discuss possible resolutions. However, one problem with current online systems is they do not categorize data, data sets, and users using attributes.

Modern energy monitoring systems are capable of capturing and managing large volumes of data. However, many users do not have the expertise to analyze this data to gain insight into the operation of their energy network(s). Furthermore, even those who may have the expertise to analyze the data may not have the time or the resources to do so effectively. The disclosed embodiments relate to an approach to data analysis that provides tools to a community of users having expertise in a variety of areas. Using these tools, this community of users can leverage the collective intellectual capacity of the community and help each other turn volumes of monitoring system data into actionable information. Some exemplary applications of the disclosed embodiments include: identifying trends; identifying undetected, unanticipated, or unmeasurable, significance from isolated or seemingly innocuous occurrences/events; exposing perceived-isolated occurrences/events to demonstrate or reveal unseen/undetected relationships; and distinguishing meaningful data from meaningless data, e.g. noise, in large volumes of data. Thus, using a “social network” approach to data analysis by providing tools to a community of users with expertise in a variety of areas enhances the quality of the analysis while reducing the amount of time it can take to understand and resolve an issue. Furthermore, the social network approach can reduce the amount of time to find the root cause of a power related issue or problem.

A social network provides a means for a community of users with a common interest to communicate. Such user communities may be defined within an organization or entity or may be defined by the shared interests of individuals, organizations or combinations thereof, and thereby extend across organizational or other boundaries. Many social networks are web based but they do not have to be. For example, other communications protocols or media, whether or not TCP/IP based, may be utilized. A social network can provide tools to enhance communication between users and increase productivity within a user's industry. Such tools may include blogging, chat, or discussion groups. With regard to the disclosed embodiments, the social network is provided or made available to a community of users such as building managers who are responsible for managing power related consumption, power related problems/outages, or a number of other tasks that may be associated with power distribution, consumption and monitoring.

Generally, an Energy Management system may be communicatively linked with an internet based social networking system to aid in energy and power quality analysis, as well as acting as a communication medium between a provider of relevant products and services and an end user customer having a need therefore, as well as between two or more such providers and end users. For example, a facility engineer at an industrial site may experience a power quality related event such as a voltage transient. The site's EEM system collects all of the information relevant to the event and then offers the engineer the option of uploading or otherwise sending the event details to an internet based repository that other similar EEM users, as well as other subject matter experts, product and service providers, have access to. Prior or subsequent to uploading data, the engineer can search for and compare existing event details in the database with similar characteristics and/or request assistance in analyzing the voltage transient details from the other users and experts in the community, as will be described.

More specifically, the energy management system may include one or more sources of measurement data, which may include intelligent electronic devices, other measurement systems such as process automation systems, and web services, such as weather services. A central computer or cluster of computers may also be included which executes software that receives measurement data from one or more sources, archives the data and presents the data to one or more users for viewing and analysis. Further, an online service that captures and manages the relationships between a community of users, measurement data acquired by those users and data analysis operations performed by users on the measurement data may also be included.

Reference will now be made to the accompanying drawings, which form a part hereof, and which show, by way of illustration, specific exemplary embodiments. The modules in the figures are not necessarily to scale, emphasis instead being placed upon illustrating the principles of the invention. Moreover, in the figures, like referenced numerals designate corresponding parts throughout the different views. The principles described herein may, however be embodied in many different forms, and this specification should not be construed to limit the claims. Rather, these embodiments are provided so that the disclosure will be thorough and complete to those skilled in the art.

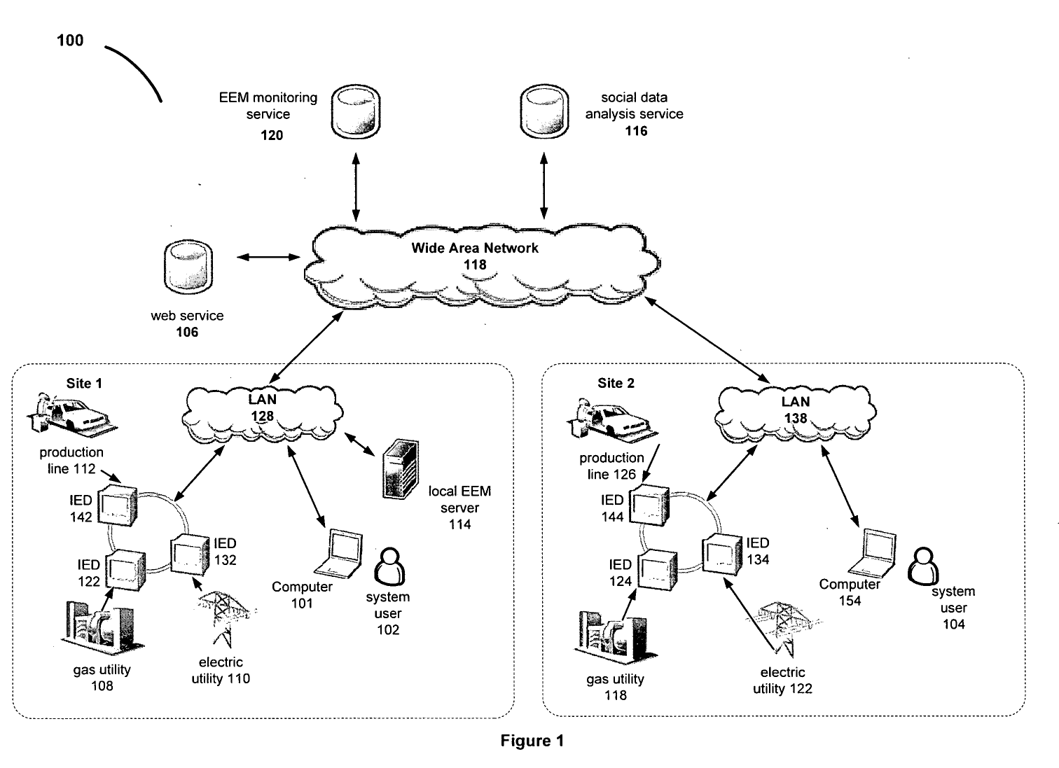

FIG. 1 illustrates a high level view of an exemplary system architecture 100, according to one embodiment. The architecture 100 includes an enterprise energy management service 120, a social data analysis service 116, data source 106, and at least two local area networks 128, 138, denoted in the figure as “site 1,” and “site 2,” coupled together via a wide are network 118.

Enterprise energy management monitoring service 120, social data analysis service 116, local enterprise energy management server 114, and user devices 101 and 154 may represent various types of computing devices. These devices may generally include any device that is capable of performing computations and sending and/or receiving data over a network. The wide area network 118 and/or local area networks 128, 138 may include the Internet, a public or private intranet, an extranet, or any other network configuration to enable transfer of data and commands including wired and or wireless networks, or combinations thereof. An exemplary network configuration uses the transport Control Protocol/Internet Protocol (“TCP/IP”) network protocol suite, however, other Internet Protocol based networks are also contemplated. Communications may also include IP tunneling protocols such as those that allow virtual private networks coupling multiple intranets or extranets together via the Internet. The network may support application protocols, such as, for example, telnet, POP3, Mime, HTTP, HTTPS, PPP, TCP/IP, SMTP, proprietary protocols, or any other network protocols known in the art. For example, user devices 101 and 154 may be configured to execute a browser application that employs HTTP to request information, such as a web page, from a web server. The illustrated computing devices communicate using the wide area and local area networks 118, 128, and 138. Wide and local area networks 118, 128, and 138 may include any suitable communication network including wire line and wireless networks using any suitable network protocol and may include sub-networks such as other local area networks or wide area networks.

The measurement and analysis of power quality not only involves voltage and current measurements but other types of data may be relevant as well, such as temperature and weather conditions which may also be considered power management related data. Other relevant data types may include financial market data, current news events or other data which may be associated with or have relevance to the delivery and/or consumption of energy. The data sources 106, 108, 110, 112, 118, 122, and 126 may represent some of the possible sources of data that can be included in the data analysis. For example, the IED's 122 and 124 may collect energy related data associated with a gas utility. The IED's 132 and 134 may collect energy related data associated with an electric utility, and the IED's 142 and 144 may collect energy related data associated with a process control system such as a production line. The data source 106 may represent additional data sources that offer data relevant to the analysis of energy use. One example of such relevant data might be the hourly ambient temperature readings offered by a weather service company. Other examples include financial market data, local news data, national news data, and world news data. Other data sources not listed above may also be included in addition to those already stated.

The EEM monitoring service 120 may include a social data analysis service 116. The social data analysis service 116 may be in the form of a database but can be any computer related software module that is capable of storing and presenting views and analysis of the data collected by the EEM monitoring service 120 as described herein. The social data analysis service 116 may be combined logically and/or physically with the EEM monitoring service 120, or may be provided separately. In one embodiment, it may be more desirable to maintain the social data analysis 116 separated, logically and/or physically, from the EEM monitoring service 120 for improved reliability and to minimize security risks and data loss. In one embodiment, the EEM monitoring service 120 may be located on the enterprise energy management social network service provider's local area network. The social data analysis service 116 may be provided via a sub-network or local area network (not shown) that is separate from the sub-network or local area network (not shown) to which the EEM monitoring service 120 is coupled. The social data analysis service 116 may be hosted by an independent vendor/company that is capable of polling the EEM monitoring service 120 to obtain the requisite aggregate energy related or other data.

Site 1 and Site 2 represent two of the many possible configurations that may be used in a given site. System users 102 and 104 may represent possible members of the social network described herein. For example, system user 102 may be a building manager for building A while user 104 may be a building manager for building B. System users 102 and 104 may be unaffiliated with each other. In an alternative embodiment, the users of the architecture 100 may be limited to users of a particular organization or entity. The configurations of sites 1 and 2 are only exemplary and should not be used to limit this disclosure.

The EEM monitoring service 120 may collect energy related data from several IED's within several unrelated and/or unaffiliated sites. The EEM monitoring service 120 may also collect data from other sources that may have an impact on power or power quality. For example, the EEM monitoring service 120 may collect power related data from an online weather service. The EEM monitoring service 120 may store the power related data received by each IED and categorize the data according to various attributes.

Site 1 illustrates a common logical architecture for an enterprise energy management monitoring system at a typical installation, which may be physically located across one or more geographic regions. Several intelligent electronic devices (IEDs) 122, 132, 142 may be attached at various points of one or more energy distribution networks such as electric, gas, steam, etc. (not shown). At site 1, the IED's 122, 132, and 142 may each monitor energy related devices at different points within a local area network 128. For example, the IED 122 may represent a monitoring device for the gas utility, the IED 132 may represent a monitoring device for the electric utility and the IED 142 may represent a monitoring device for a production line, such as a device which monitors the energy consumption of the machines which make up the production line. A local enterprise energy management server 114 may collect data from one data sources 106, 108, 110, and 112 via the IED's 122, 132, and 142. The IED's 122,132, 142 may push the data to the enterprise energy management server 114 or the enterprise energy management server 114 may periodically poll the data sources for updates, or a combination of both.

In one embodiment, the enterprise energy management server (EEM server) 114 polls the IED's 122, 132, and 142 at various intervals and collects energy related data gathered by each IED. The EEM server 114 processes the data and presents the data to one or more users at the site such as system user 102. A system user 102 may view the data provided by EEM server 114 using laptop computer 101 or other device (not shown).

As described above, an enterprise energy management server 114 may collect power related data from one or more IED's. An EEM monitoring service 120 may collect power related from one or more EEM servers 114. Alternatively, an EEM server 114 may collect data from the IED's directly in addition to or in lieu of collecting data from an EEM server 114. An EEM monitoring service 120 may consist of one or more computing devices. The social data analysis service 116 may provide users with tools for shared views and analysis of the data. The social data analysis service 116 may also consist of one or more computing devices. The social data analysis service 116 may be hosted by the same entity as the EEM monitoring service 120 or it may be provided by two or more distinct entities. The social data analysis service 116 and the EEM monitoring service 120 may also reside in an area of a network such as a demilitarized zone (DMZ) to increase security by minimizing the possibility of intruders from the enterprise energy management server 114 or other sensitive/secure data on a network.

Site 2 includes data sources 118, 122, and 124; IED's 124, 134, 144; laptop computer 154, and system user 104. At site 2, the IED's 124, 134, and 144, and a computer 154 may be connected through the local area network 138. Site 2 may include an alternate configuration of IED's. The IED's 124, 134, and 144 may collect similar energy related data as IED's 122,132, and 142 in site 1 or they may be collecting energy related data from other sources. The laptop computer 154 may include a web based application for monitoring the IED's 124, 134, and 144 of Site 2. More specifically, instead of having an EEM server 114 as is provided at site 1, at site 2, the user subscribes to an EEM service that acquires data from the site, archives it and offers the data back to the user as a service. Thus, at site 2, the IED's 124, 134, and 144 send their associated energy related data directly through a central online EEM service 120 provided by an electric utility entity or an online service provider which archives, process and presents this data to one or more site 2 users. Thus, a system user 104 can view energy related data associated with site 2 through an online software tool. This approach may have an advantage of simplifying EEM monitoring system deployment because an additional/dedicated server may not be required.

A web service 106 represents one or more additional external data sources which may offer data relevant to the analysis of energy use at a local site, such as data which may have an impact on power distribution, power consumption and/or power quality. A web service 106 may be offered locally or remotely from a particular local site. For example, a web service 106 may include a weather data provider, such as a weather service company, which provides the hourly ambient temperature readings, or other real-time or forecasted weather related data. This data may be correlated with energy consumption data for energy management purposes.

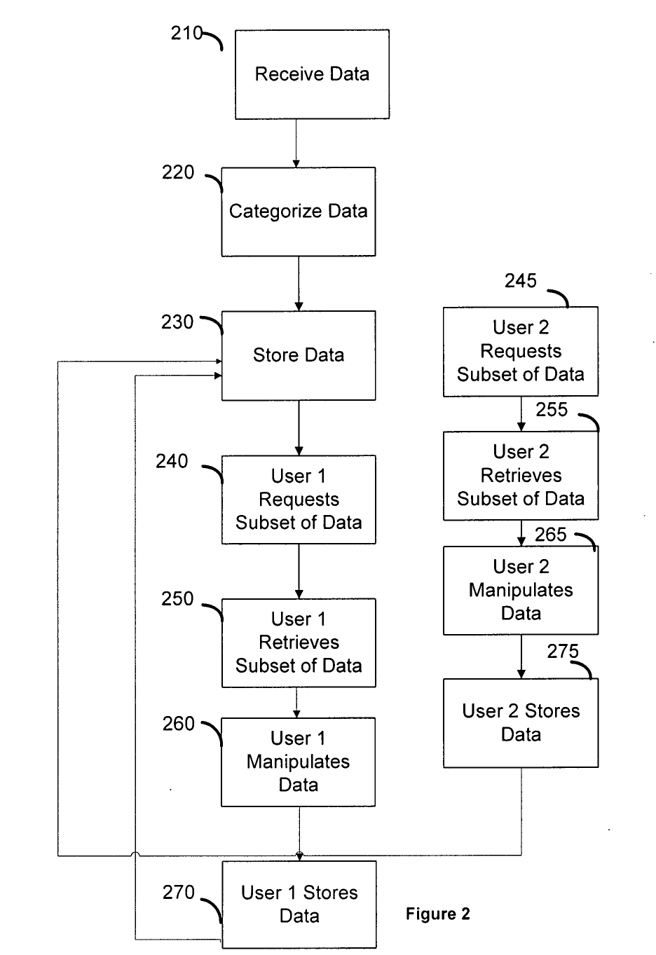

FIG. 2 is a flow diagram illustrating operation of one embodiment of an exemplary system architecture 100. Operation begins with receiving energy related data at block 210. At block 220, the energy related data is categorized according to predetermined categories. Next, at block 230, the categorized data is stored in a repository. A user accesses the architecture 100 and requests a subset of the categorized energy related data at block 240. The user receives the requested subset of the energy related data at block 250. Next, at block 260, the user manipulates the received data. For example, the data can be manipulated by adding additional sources of data or isolating segments of the data or further categorizing the data with new categories. At block 270, the user may choose to store the manipulated data in the data repository at block 230 for future reference or to provide other users access to the user's manipulated data. A second user who is unaffiliated with the first user may also retrieve a subset of the energy related data, manipulate the data and store it within the repository. The second user accesses the stored data at block 245, retrieves a subset of the stored data at block 255, manipulates the retrieved subset at block 265, and stores the manipulated data within the repository at block 270. Thus, the repository can handle multiple simultaneous requests for distinct subsets of data and store user manipulated data.

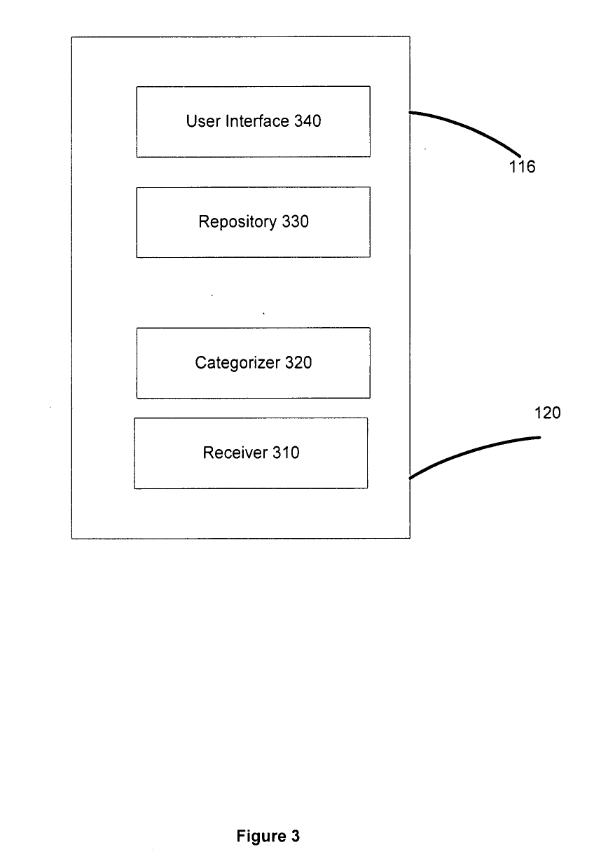

FIG. 3 is block diagram of one embodiment of a portion of the system architecture 100. System architecture 100 includes the EEM monitoring service 120 and the social data analysis service 116. The EEM monitoring service 120 may include a receiver 310 and a categorizer 320. The social data analysis service 116 may include a repository 330 and a user interface 340. The receiver 310 receives energy related data from one or more users of the social network. The categorizer 320 categorizes the data into predefined categories. A repository 330 may store the categorized data in a database or other storage device. The user interface 340 may provide a front end to users which incorporates tools for users to retrieve, manipulate, and view some or all of the data within the repository 330. The user interface 340 may also provide users with an option to store the manipulated or transformed data back within the repository 330 for further viewing by the user or other users of the social network.

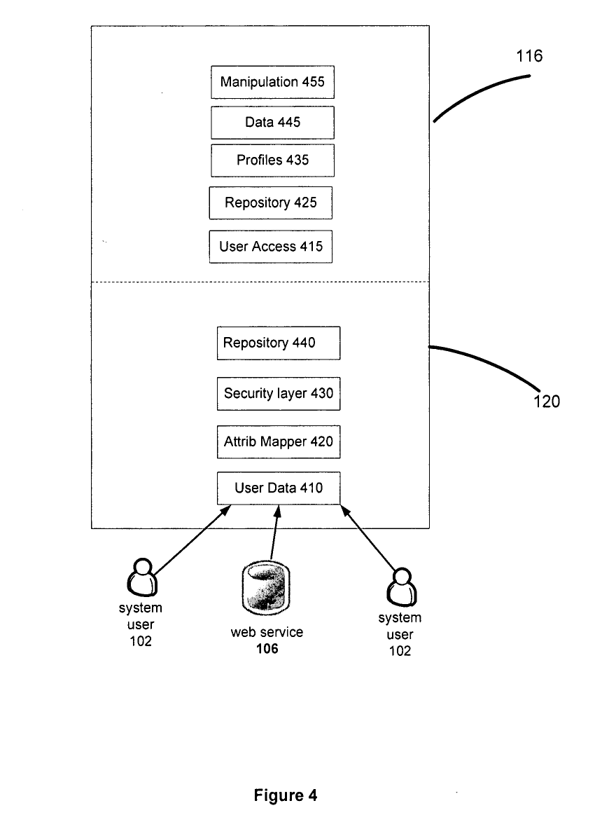

FIG. 4 is an alternate and more detailed illustration of one embodiment of a portion of the system architecture 100. The EEM monitoring service 120 may include a user data module 410, an attribute mapper 420, a security layer 430, and a repository 440. The user data module 410 collects energy related data from all of the local area network EEM servers or IED's that are part of, e.g. participating in, the social network. System user 102 and system user 104 may push their associated data to user data module 410. Additionally, data from web service 106 may also be pushed to user data module 410 or pulled/retrieved by user data module 410. The user data module 410 may associate data collected from each IED, referred to as a data set, within a particular site to the user associated with that IED, such as by tagging the data with an indicator which indicates the user. Thus, each user or site may have a number of energy related data sets associated with it. These data sets may be sorted and combined by the user data module 410. A listing of users who are members of the EEM network may be pushed from the user data module 410 to the social data analysis service 116 to ensure that an accurate mapping of users and data is achieved.

The EEM monitoring service 120 may also include an attribute mapper module 420. The attribute mapper module 420 may correlate various attributes to the data sets collected by the user data module 410. A tag is generally a piece of data representative of the value of a particular attribute. For clarity herein, attributes, and their possible values, and tags, and their possible values, will be referred to interchangeably. Exemplary attributes include company affiliation, industry, geographic location, areas of expertise, or other data attributes of interest. The EEM monitoring service 120 may further include a security layer module 430 to ensure the collected data is stripped of any sensitive data that is specific to a site or a user. For example, the security layer module 430 may remove data representative of the associated company name or the exact physical or logical location of the site from the data set. The security layer module 430 may also remove additional data depending on configurations/settings made by users who are part of the social data analysis network and have chosen to upload their data to the repository 440. The security layer module 430 may help provide comfort to users of a social network who may be concerned their data or other confidential information may be exposed to the entire community or other users coupled with the wide area network 118 (shown in FIG. 1). The data repository module 440 stores the data sets with associated attributes, stripped from any sensitive or secure information. The data repository module 440 may include a database or other software module that is capable of storing the power related data. The data repository module 440 may push the energy related data directly to the social data analysis service 116 or the social data analysis service 116 may pull data from the data repository module 440. A social data analysis service 116 may provide users with tools for shared views and analysis of the data stored within the data repository 440. The social data analysis service 116 may be located on another server/computer module or on an entirely different network. Both the EEM service and the social data analysis service 116 may be hosted by an online service provider outside of the electric network industry. Alternatively, social data analysis service may be incorporated within the EEM service 116.

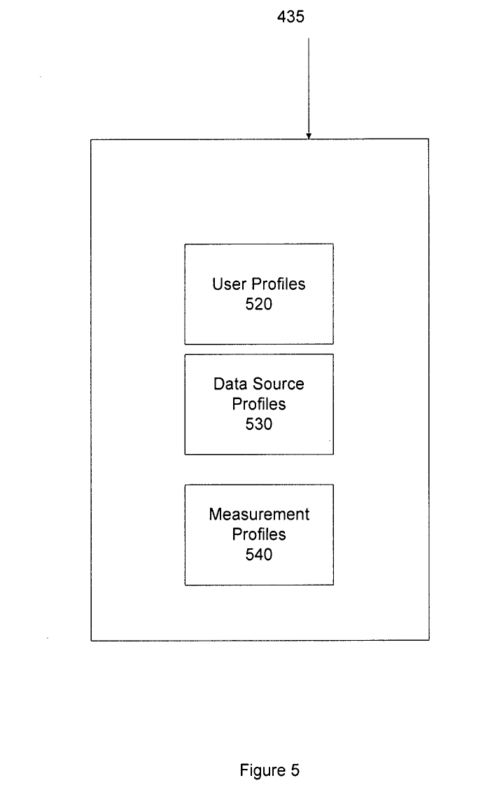

The social data analysis service 116 may include a manipulation module 455, a data module 455, profile module 435, repository module 425 and a user access module 415. The data layer 445 retrieves, or is provided with, the data from the data repository module 440. Once the data is obtained, the social data analysis service provides a medium for viewing, analysis, and additional configurations of data through the manipulation module 455 and the profile module 435. Once data is manipulated, the data may be stored in a repository 425. The repository 425 may contain several databases. For example, one database may store the manipulated energy related data and another database may store the categorized data prior to manipulation. The profile module 435 will be discussed in greater detail in FIG. 5. The user access module 460 may include a listing of the users who have access to the social network and their associated data. Generally, a user will have a login and password to access the social network. The login may be a site id if multiple users from the same site may be accessing the social network. Alternatively, multiple users of a given site may each have an associated login and password or other source of accessing the data within the repository 440. This information may be stored in a user access table or some other secure data storage means. Typically, a user will not have access to the social network or the associated data unless that user's energy related data is part of the data repository 440, i.e. they are a participant in the social network.

A number of methods are used to highlight the relationships between data sources, measurements and users, including the use of profiles containing metadata. FIG. 5 is a more detailed view of the modules that may be part of the profile module 435 of FIG. 4. As shown in FIG. 5, user profiles 520 may contain information that classifies users by attributes such as company affiliation, industry, geographic location, areas of expertise, and data sources of interest or anything else that can be used to classify users. Data source profiles 530 captures attributes details such as monitoring point description, energy load type, physical location, and other available measurements. Measurement profiles 540 can include attributes details such as type (i.e. voltage, temperature, current, precipitation levels, consumption, or other types of measurements), update interval, resolution, or other details that can be measurable or change depending on time or conditions. Once data sources, measurements and users have been profiled, this metadata can be used to present relevant data analysis operations and views based on relationships between users and their data and analysis operations they have performed. For example, a user can search for the most popular types of analysis performed by other users in the same industry and with similar monitoring applications. Specifically, a building manager interested in reducing energy usage may find that other users with a similar profile typically model the entire building energy consumption against external temperature.

Data shared on an online service is searchable by attributes contained within its profile, and can be incorporated into data analysis operations. For example, a building manager wishes to view energy consumption versus external temperature. However, the building manager may not have temperature related data for the site for which the building manager is responsible. A search on the online service may turn up an NOAA (National Oceanic and Atmospheric Administration) data source with interval temperature measurements for the building manager's location. The building manager will now be able to incorporate this data into the analysis. In another example, users can highlight a data set or analysis result (their own or one shared via the online service) and add comments. Such user comments can be organized as a discussion thread and can be searchable by other users. Users may also be able to control who has access to their data and what data they are willing to share with others through the online service. The user selection can make use of user profile metadata. For example, an industrial energy engineer may choose to share process energy consumption with everyone in his company and key account representatives at his local electric utility. Users can also share a data set and ask others to provide possible solutions to a question related to the data set or a more general question regarding configuration. Once a working solution is found, users can provide positive feedback to those who provided the solution within a rating system that builds the reputation of those who helped within an area of expertise. A rating system can also help other users with a similar problem can decide whether or not to implement the proposed change/follow the received advice.

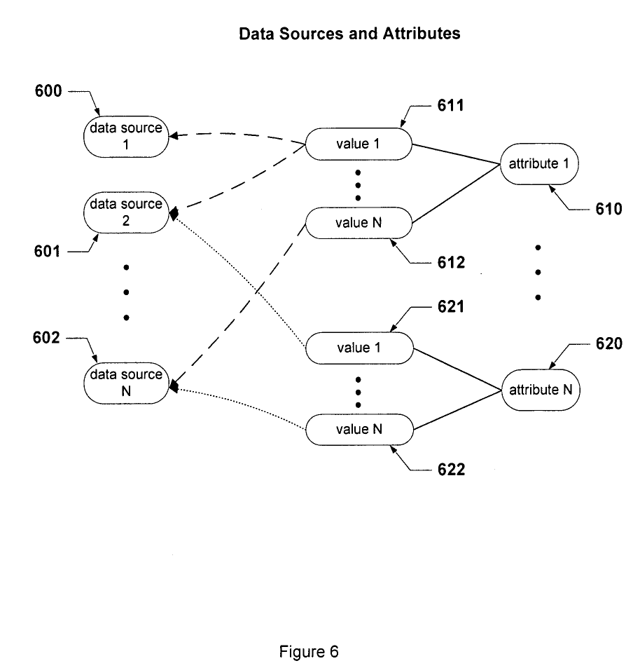

FIG. 6 provides a visual description of the concept of attributes as they may be used here. Attributes include both a name and value and are often structured in a hierarchy, the less formal and increasingly popular tagging classification approach simply assigns a descriptive label. Attributes have the advantage of defined structures and terms, which can make it easier to group related terms. The informal nature of tags grants them the advantage of being easily extensible—any participant using an information system can typically create new tags instantly. For example, an attribute-based classification approach that describes a location using three attributes: State, City and Street. These attributes could be organized within a hierarchy with State at the top, followed by City and then Street. A monitoring device location could be described by the attributes State=“IL”, City=“Chicago” and Street=“Michigan Avenue”. If a user wanted to view a list of all cities with monitoring locations, they could simply ask an information system for all values of the City attribute.

Using the informal tagging classification approach, a user may identify the same location simply by the labels “IL”, “Chicago” and “Michigan Avenue”. These labels have no defined relationship with each other; a tagging classification approach typically does not enforce a hierarchy for labels. This informal approach does, however, allow users to quickly create their own tags. A user may, for example, add a label “Northwest corner” as an additional location descriptor for a monitoring location. To minimize multiple tags that describe the same concept (such as “Michigan Avenue” and “Michigan Ave.”) methods such as tag clouds and auto-completion of tags may be used. The attributes and tagging approaches are not mutually exclusive. A monitoring system may employ both for adding metadata to data sources, measurements and users. For more details on attributes, see copending U.S. application Ser. No. 11/845,630 entitled “Alarm Management Using Source Attributes.”

FIG. 6 shows one embodiment of the relationship between attributes attribute values and entities. In particular, one or more attribute values 611, 612, 621 and 622 for one or more attributes 610 and 620 are assigned to one or more entities such as the data sources 600, 601 and 602. In the present example, the first data source 600 and the second data source 601 have been assigned a first attribute value 611 corresponding to the first attribute 610. However, the third data source 602 has been assigned a second attribute value 612 corresponding to the first attribute 610. For instance, the first attribute 610 might refer to the city wherein a data source is located. Assuming that the first and second data sources 600 and 601 are located in City A and that the third data source 602 is located in City B, the first attribute value 611 would be City A and the second attribute value 612 would be City B. While the first data source 600 has only been assigned one attribute value 611, the second and third data sources 601 and 602 have each been assigned two attribute values corresponding to the first and second attributes 610 and 320. For example, the second attribute might refer to a maximum current for the first and second data sources. Attribute value 621 may be greater or less than attribute value 622 depending on which data source 601 or 602 is configured for a higher maximum current. FIG. 6 illustrates that new data sources can be easily integrated. Rather than configure each new data source independently of others, the new data source can simply be associated with existing attributes and attribute values. The associated alarms are already defined for those attributes and attribute values. Further, the alarms associated with a particular data source can be altered by simply changing the attributes and attribute values associated with the particular data source. This advantageously eliminates the need to reconfigure alarms and alarm conditions at the data source itself. The data source can continue to report measurement values, but the reported values can be interpreted in a different way. This provides flexibility and scalability to the ability to monitor the various data sources.

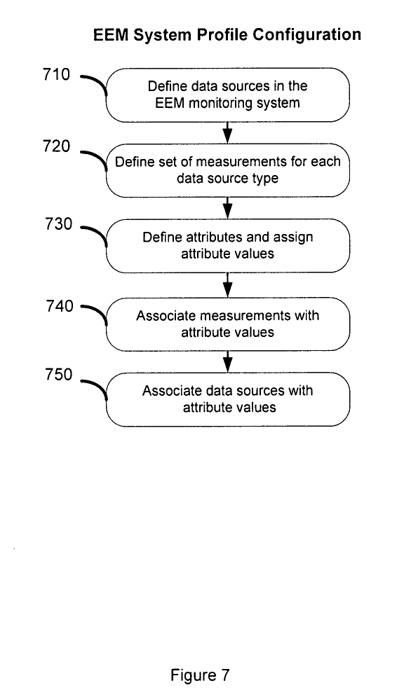

FIG. 7 illustrates the process of profiling a monitoring system by creating attributes and associating attribute values to data sources and measurements. At block 710, data sources in the EEM monitoring system may be defined. For example, one data source may be temperature while another data source may be from an IED collected data relative to an electric utility. Next, at block 720 a set of measurements for each data source type may be defined. Next, at block 730, attributes and attribute values can be defined. For example, an attribute may be the nominal voltage while the attribute value may be 480 volts. Next, at block 740, measurements are associated with the attribute values. At block 750, data sources are associated with attribute values. Thus, referring briefly back to FIG. 2, the IED's 222, 232, and 242 within site 1, key information for each IED is programmed into the software running on the local EEM server so that the server can gather data from each IED. Attributes describing each IED (which may include location, load type, etc.) are defined. Relevant attribute values are associated with each IED. Attributes describing measurements offered by the IEDs (such as phase, type, etc.) are also defined and relevant attribute values are associated with each measurement taken.

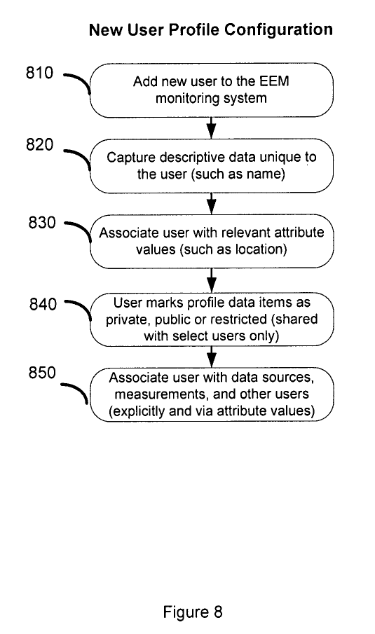

FIG. 8 highlights the process of profiling users within the social data analysis service including the steps of defining users within the system, defining attributes and attribute values, and associating users with attribute values that describe them and attribute values that describe their interests/needs. The process begins at block 810 by adding the new user will be added to the EEM monitoring system. At block 820, descriptive data that is unique to the specific user such as the user name and a password is captured. This may be done using an online form, through an account executive, or by any other method a new user can be added to a software system. At block 830, the user may be associated with other relevant attribute values such as the location of the site(s) the user is monitoring. Next, at block 840, the user can mark profile data items as private, public or restricted. Public data items will be accessible to all users, private data items may be items the user does not wish to share with anyone, but would like to include in the related analysis. If data that is marked as restricted, the user can select which users can have access to the specific data. At block 850, users are associated with data sources, measurements, and other users through the attribute values. For example, key information such as name, login, credentials, etc. of system user 102 (shown in FIG. 1) may be associated with system user 102. Attributes that describe system user 102 (such as Organization, Location, etc) are defined and relevant attribute values are associated with system user 102. Attributes describing this user's interests (which may include Load Type, Location, etc) are also defined and relevant attribute values are associated with the system user 102.

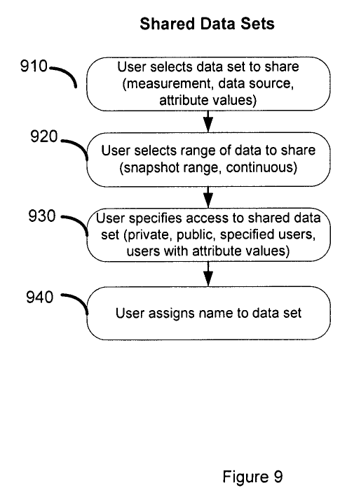

FIG. 9 highlights the process of creating and managing shared data sets. At block 910, a user can select the data set to share such as measurements, data sources, or attribute values. At block 920, the user selects the range of data to share such as a snapshot range or a continuous range. At block 930, the user specifies the access to the shared data set such as private, public, specified users, users with specific attribute values, etc. Finally, at block 940, the user assigns a name to the data set to for future reference.

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A system for analyzing power management data by a community of users having a common interest, the system comprising:
a user data module operative to collect power management related data;
a attribute module coupled with the user data module operative to categorize the power management related data into one of a plurality of categories; and
a manipulation module coupled with the user data module and the attribute module and operative to respond to a manipulation request by manipulating the power management related data and presenting the manipulated energy related data.

2. The system of claim 1 wherein the user data module is further configured to receive first power management related data from a first power management device associated with a first user and second power management data from a second power management device associated with a second user.

3. The system of claim 1 wherein the user data module receives power management related data from a data source outside of the community of users.

4. The system of claim 1 wherein the first and second power management related data comprises data representative of electrical energy parameters of at least a portion of an electrical power distribution system.

5. The system of claim 1 wherein the power management related data comprises at least one of weather data, financial market data, local news data, national news data, world news data, energy distribution data associated with distribution of electrical energy through at least a portion of an electrical power distribution system, or combinations thereof.

6. The system of claim 1 wherein the attribute module is further configured to at least one of tag received power management data, categorize received power management data based on tags associated therewith, or combinations thereof.

7. The system of claim 1 wherein the manipulation module is configured to store manipulated power management data independent of the power management data.

8. The system of claim 1 further configured to store manipulated power management data independent of the categorized power management data.

9. A system for analyzing power management data by a community of users having a common interest, the system comprising:
a receiver operative to receive power management related data from at least one user of a community of users;
a categorizer operative to categorize the received power management related data into at least one of a plurality of predetermined categories;
a repository operative to store the categorized power management related data in a database accessible to the community of users; and
a interactive user interface operative to allow a first user of the community of users to retrieve from the database a first subset of the categorized power management related data categorized in one or more selected categories of the plurality of categories, allowing the first user to manipulate the retrieved first subset of the categorized power management related data, and allowing the first user to store the manipulated power management related data in the database.

10. A computer-readable storage medium comprising a set of instructions to direct a computer system to perform the acts of:
receiving power management related data from at least one user of a community of users;
categorizing the received power management related data into at least one of a plurality of predetermined categories;
storing the categorized power management related data in a database accessible to the community of users;
allowing a first user of the community of users to retrieve from the database a first subset of the categorized power management related data categorized in one or more selected categories of the plurality of categories;
allowing the first user to manipulate the retrieved first subset of the categorized power management related data; and
allowing the first user to store the manipulated power management related data in the database.

11. A method of analyzing power management data by a community of users having a common interest, the method comprising:
receiving power management related data from at least one user of the community of users;
categorizing the received power management related data into at least one of a plurality of categories;
storing the categorized power management related data in a database accessible to the community of users;
allowing a first user of the community of users to retrieve from the database a first subset of the categorized power management related data categorized in one or more selected categories of the plurality of categories;
allowing the first user to manipulate the retrieved first subset of the categorized power management related data; and
allowing the first user to store the manipulated power management related data in the database.

12. The method of claim 11 wherein the at least one user is unaffiliated with the first user.

13. The method of claim 11 wherein receiving power management related data comprises receiving the power management related data from a power management device associated with the at least one user.

14. The method of claim 11 wherein the receiving further comprises receiving power management related data from a data source outside the community of users.

15. The method of claim 11 wherein the power management related data comprises data representative of electrical energy parameters of at least a portion of an electrical power distribution system.

16. The method of claim 11 wherein the power management related data comprises at least one of weather data, financial market data, local new data, national news data, world news data, power management data associated with a distribution of electrical energy through at least a portion of an electrical power distribution system, or combinations thereof.

17. The method of claim 11 wherein categorizing the received power management related data further comprises at least one of tagging the received power management data, categorizing the received power management data based on tags associated therewith, or combinations thereof.

18. The method of claim 11 wherein allowing the first user to manipulate the retrieved first subset of the categorized power management related data further comprises at least one of formatting the categorized power management related data, presenting the categorized power management related data, transforming the categorized power management related data, deriving other data from the categorized power management related data, or combinations thereof.

19. The method of claim 11 wherein allowing the first user to store the manipulated power management related data in the database comprises storing the manipulated power management related data in a repository that is independent of the power management data.

20. The method of claim 11 further comprising:
allowing a second user of the community of users to retrieve data from the database comprising a second subset of the categorized power management data that is categorized in one or more selected categories of the plurality of categories, a subset of the stored manipulated power management data, or combinations thereof; and
allowing the second user to manipulate the retrieved data, wherein the manipulation comprises at least one of formatting the retrieved data, presenting the retrieved data, transforming the retrieved data, deriving other data from the retrieved data, or combinations thereof.
